(19) United States
(12) Patent Application Publication
(10) Pub. No.: US 2013/0046686 A1
(43) Pub. Date: Feb. 21, 2013

(54) PAYMENT PROCESSING SYSTEM AND METHOD

(71) Applicants: Bradford D. Ress, Boca Raton, FL (US); Victor Alan Bates, New Port Richey, FL (US)

(72) Inventors: Bradford D. Ress, Boca Raton, FL (US); Victor Alan Bates, New Port Richey, FL (US)

(21) Appl. No.: 13/213,034

(22) Filed: Aug. 18, 2011

(51) Int. Cl. G06Q 20/14

(52) U.S. Cl. 705/40

(57) ABSTRACT

A system, method and stored program for processing payments and other financial transactions. The payment processing system of the present invention includes an input device for capturing information relevant to a customer's transaction (for example, credit card information) and storing that information securely associated with the customer. When it is determined that the customer owes a balance (for example, after an insurance company or other third party payor pays a portion of the customer's insurance claim), the balance remaining due is then calculated and submitted as a new financial transaction, using the stored information associated with the customer, e.g., in a new credit card charge, without having placed a hold on those funds as apart of an earlier transaction.

### BACKGROUND OF THE INVENTION

There are many instances where a customer desires goods or services and intends to pay with a financial instrument such as a credit card, but neither the customer nor the merchant know the exact amount of the purchase—or how much the customer will be required to pay. Sometimes this uncertainty is because the amount of time or materials is not known at the time of the initial discussions, and other times a third party is involved and it is uncertain whether the third party will pay, and if so, how much the third party will pay. This is especially true in the provision of health care services, where the time required and the services required are uncertain initially, it may be unknown what tests will be required and it may be several weeks before determining how much of the cost a third-party payor such as an insurance company will pay.

The conventional approach for a prudent medical office is to get the patient to pay for the copayment at the time services are rendered, then to await an “explanation of benefits” and payment from the insurance company. Often, the insurance company does not pay the entire balance, either because some of the services were not covered by the insurance policy or because the insurance company does not allow as much for a service as the provider charged. In any event, some patients have a balance due after insurance has paid what it will pay and the medical practice must prepare and mail a bill and await payment. This involves some delay, for the mails out and back and for processing by the patient. As a result, many medical practices have significant accounts receivables—and desire to reduce the amount due in the accounts receivable by collecting the accounts quicker and easier (preferably with less cost and effort).

The present billing and collection system is made even more complicated when there are additional payors, such as a governmental unit or a second insurance company. A governmental unit may be involved in the case of Medicare or Medicaid, in the case of a worker's compensation situation or in the case of a tort claim (another party's auto insurance may pay for treatment for cervical strain from an auto accident, but not for weight loss consultation or treatment of a pre-existing condition like diabetes).

Patients do not want the bother of receiving a bill for the balance and then having to fill out a form to charge their credit card (or write a check), then mail the payment and a stub to the medical practice. Practices do not want the expense and inefficiency of mailing multiple statements, postage, telephone calls and collections agents to collect their accounts receivable.

Process for obtaining and maintaining personal and/or financial information, such as credit card information, is a concern to many governments (both national and state governments) as well as standards organizations. For example, the Payment Card Industry Data Security Standards (PCI-DSS) discourages the storage of cardholder data and specifically forbids the storing of data such as unencrypted card numbers or codes such as the CVV and CVV2 codes. If merchants, physicians or processors have a business reason to store such card information, including the name and account number, PCI-DSS requires that this data to be encrypted or made otherwise unreadable and stored in a physically and/or digitally secure environment. Any improperly secured card data found in databases, log files, audit trails, photocopies or on written forms can result in serious consequences for the merchant/physician, especially if a compromise of the data has occurred. Fines can range up to $100,000 per month for PCI compliance violations. Further, the bank or other processor may either terminate the relationship for the merchant/physician or increase the transaction fees. Some governments have established criminal penalties for improper use or disclosure of personal and/or financial information and merchants/physicians may be subject to civil suits for damages for the compromise of personal and/or financial information. Thus, significant consequences may occur as a result of improper or negligent storing account and/or personal information by those involved.

Various governmental units are concerned with the possibility of fraud and unauthorized transactions and the release of personal information to unauthorized entities and limit what information can become public. In some cases, the full credit card number should not be disclosed, even by including it on a payment receipt, so merchants are limiting the information to the last four digits of the credit card number. In other cases, the use of a number on the card is required for processing a transaction, and it is desirable to limit the access to that number to make sure that a transaction in fact has been authorized by the customer.

Although the present invention is described in the context of a medical practice collecting the balance of the charges from a patient after payment by a third party, it is applicable also to a variety of other situations where the customer has a balance due (or recurring charges). These other situations could include printing, legal services, facility rental such as storage units or commercial space, telecommunications services or other similar types of merchant situations.

Accordingly, the present system for collecting the balance of bills has limitations and disadvantages and presents risk that might not be immediately apparent. The present invention addresses some of these undesirable limitations and aspects to provide an improved system and method for collecting amounts due on accounts while limiting the risks involved.

### SUMMARY OF THE INVENTION

The present invention provides a payment processing system, method and stored program for obtaining payment of a balance of a bill for goods and/or services.

The present invention uses an input device to capture customer data (such as a credit card number and other related information) and store the customer data securely in conjunction with the customer or patient to which it is associated, preferably at an early stage in the customer interaction. The system of the present invention may include an interface to an accounting system keeping track of debits and credits for that customer and for determining a balance due, for example, after the insurance company has considered the claim and provided an explanation of benefits for those goods and/or services with or without a payment from the insurance company. The payment processing system of the present invention prepares a charge to the same account (e.g., credit card from the captured customer data) for the balance on the account at some point, determined by either a user input (operator initiating a payment), occurrence of an event (receipt of information from the payor) or based upon a calendar (some appointed day, such as the first business day of each calendar month).

Ideally, but optionally, the accounting system for the charges and credits is automatically coupled to the insurance company's explanation of benefits (or electronic remittance advice) so payments and other information about a customer's account and its charges are recorded so that a balance is updated automatically in response to an explanation of benefits or electronic remittance advice.

Also, desirably, but not mandatory, the system can generate an advice to the customer that the balance has remained after the insurance company payment and has been billed to his credit card. In this way, the patient is not surprised when his credit card bill arrives with additional charges posted to it.

The present invention involves end-to-end security of the information to reduce the chance that information will be misused or improperly disclosed. Compliance with governmental requirements and industry standards in this area (such as PCI-DSS directives) will reduce the risks to the customer and to the merchant.

The present invention overcomes the disadvantages and limitations of the prior art systems while providing a simple, yet effective, way of collecting the balance of an account using information provided previously and stored in association with the customer account.

Other objects and advantages of the present invention will be apparent to those of ordinary skill in the art in view of the following detailed description of the preferred embodiment taken in conjunction with the accompanying drawings.

### BRIEF DESCRIPTION OF THE DRAWINGS

FIG. 1 is a schematic diagram of the components of the present invention;

FIG. 2 is a functional depiction of an alternate embodiment of the present invention; and

FIG. 3 is a flow description for the operation of the present invention.

### DETAILED DESCRIPTION OF THE PREFERRED EMBODIMENT

The present invention relates to a payment processing system that allows for collection and secure storage of relevant information (e.g., from payments made at the time of service) as well as retrieving and providing information for payments to be made some time after services have been rendered, optionally in an automated fashion. This invention is useful for a wide range of merchants and service providers, including, but not limited to, medical and healthcare industry, e-commerce, rental, printing, legal, etc. In addition to providing typical Point of Sale virtual terminal functionality, the present invention has the ability to store consumer payment data (credit card, debit card, ACH) (and to provide appropriate security for such information, as desired or required) and utilize that secure stored payment data for future transactions (without placing an Authorization or “Hold” on the consumer's credit account).

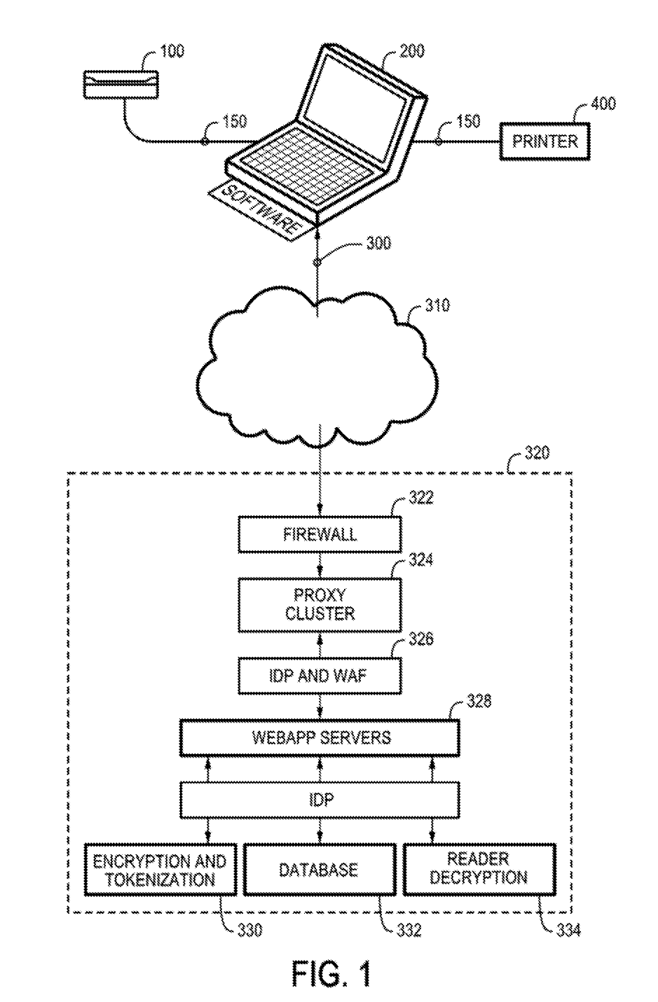

A system used to practice the present invention is shown in FIG. 1 and is comprised of an input device 100 coupled to a data processing device 200 and to telecommunications interface 300. The input device 100 may be a conventional card processing device such as a media-reading or manual input device (such as a magnetic-stripe card reader, smart card reader, RFID reader, MICR reader, PIN pad device, digital signature pad, keyboard, etc.) and is connected to the data processing device 200 through a conventional local interface (150) such as a USB port. The system typically is coupled to a printer 400 for providing receipts as well as other tangible output. Software 500 includes a Client App (software that resides on the merchant's data processing device 200 which may be a general purpose personal computer, smart phone, tablet or similar device). The telecommunications interface 300 couples the data processing device 200 to a communications network 310 which may be the Internet or an other suitable communications network such as a VPN

Also coupled to the communications network 310 are Secured Facilities 320 which comprise appropriate firewalled security layers 322 and proxy, application, encryption, tokenization, key management, data storage and other functions to maintain the financial information for use without exposing it improperly. These are shown by proxy cluster 324 providing application delivery controller, secure socket layer (SSL) and offload content caching; IDP & WAF 326 providing web application firewall; webapp servers 328 coupled via IDP to encryption and tokenization function 330, database storage 332 and decryption function 334. The decryption function 334 is provided for the card reader 100, since the card reader 100 will generate an encrypted message of the card for security purposes.

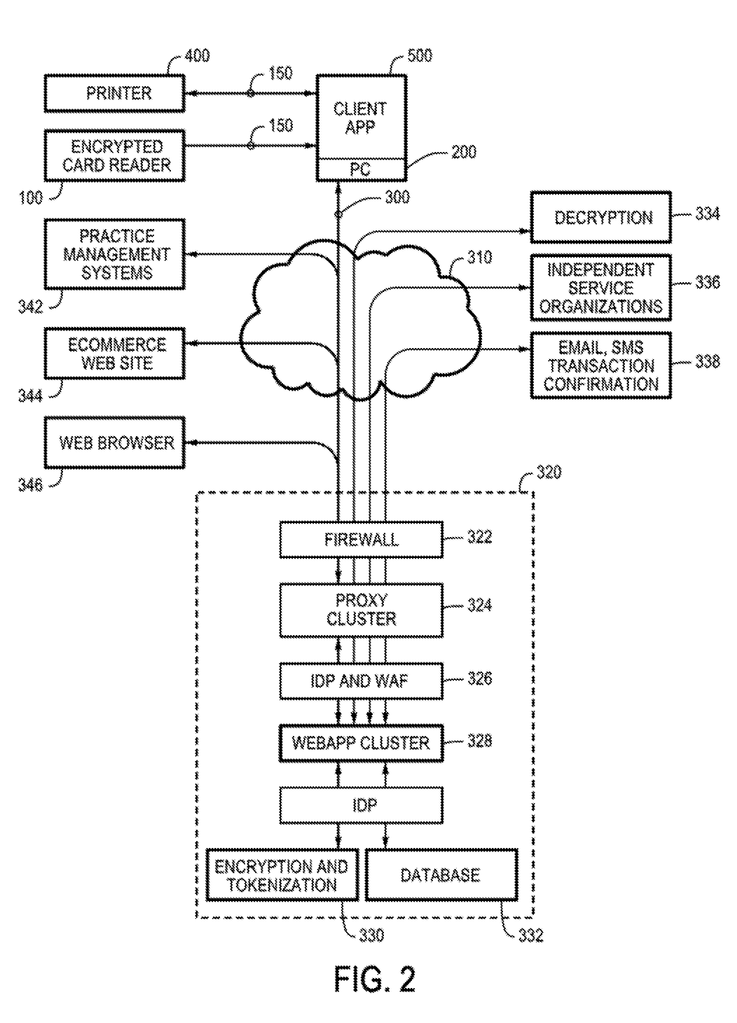

FIG. 2 is a functional view of the components of an alternate embodiment of the present invention, including some of the components of FIG. 1 and some additional components included in a typical system using the present invention. The system shown herein includes the input device 100 (an encrypted card reader as shown) along with the printer 400 attached to a personal computer 200 running software 500 (client app). The communications interface 300 couples the device to the internet 310, to which many other things are coupled, including secured facility 320, a decryption utility 334, independent service organizations 336, email and SMS functions 338, practice management software 342, one or more eCommerce websites 344 and a web browser 346. The secured facility 320 includes a firewall 322, a proxy cluster 324, IDP and web application firewall 326, webapp cluster 328, and encryption & tokenization functions 330 and database 332.

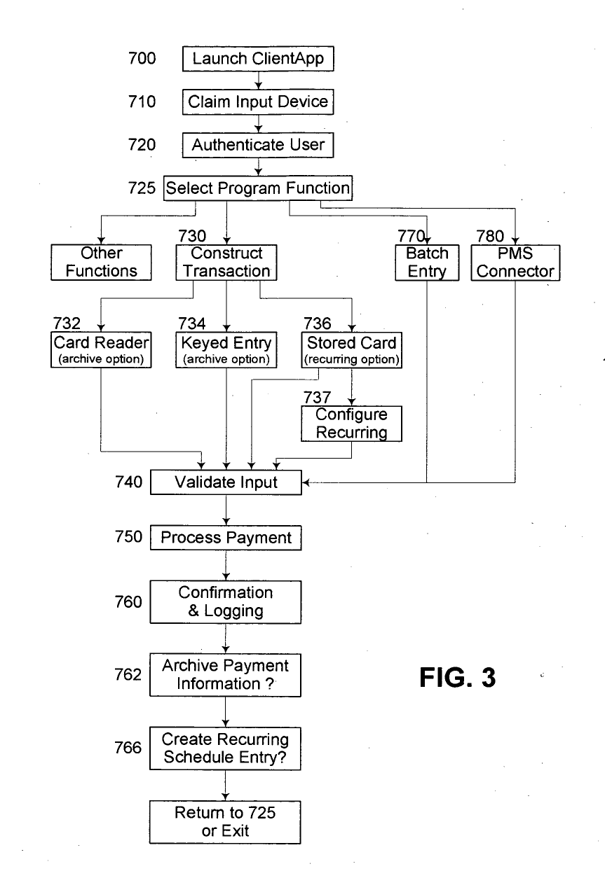

One process of using the present invention using the elements of FIGS. 1 and 2 to provide payment processing is depicted by the flow chart of FIG. 3.

Upon connecting the input device 100 (such as a secure media reader) to the merchant's data processing system 200 (e.g., a personal computer running a conventional operating system such as Windows) via local communication interface 150 (USB, Bluetooth, etc.), the ClientApp software 500 is launched at block 700.

Local interfaces 150 couple the merchant's data processing system 200, and thereby the ClientApp 500, to the printer 400 and to input device (the card reader) 100. These local interfaces can include conventional hard wired interconnections using cable through a USB or Serial port, and also include wireless methods such as encrypted Bluetooth or Near Field communication.

The merchant may also launch ClientApp 500 through usual operating system conventions, such as from a menu or icon selection. Through host-to-device authentication at block 710, the ClientApp software 500 identifies the input device100, and securely “claims” the input device 100 for exclusive use, preventing other co-resident applications on data processing system 200 from accessing the input device (card reader) 100 until released by the ClientApp 500.

Upon launch, ClientApp software 500 initiates a secure encrypted connection to the WebApp cluster 328 via telecommunications interface 300 and network 310. The WebApp cluster 328 returns to the ClientApp 500, a login window prompting the merchant for identification and authentication at block 720. The merchant enters requested credentials and logs in at block 720 via the ClientApp 500 and authenticates with the WebApp cluster 328 at Secured Facilities 320. Following successful authentication, the WebApp cluster 328 presents menus and icons via ClientApp 500 from which the merchant may select a desired function in block 725. A function may be selected immediately or the ClientApp 500 may lay dormant in the background for a predefined time period, after which authentication must be performed again.

Functions accessible from block 725 include example items such as
process payment (Construct Transaction) 730,
initiate Batch Entry 770
connect to practice management software (PMS) 780
or other functions including:
   view Transaction History,
   perform User Management,
   perform Customer (patient) Management,
   configure Software Options, and more.

If the ClientApp 500 is dormant, but remains in an authenticated state, upon detecting input device activity (such as a card swipe through a magnetic card reader), will automatically initiate communication with WebApp cluster 328, which proceeds automatically to block 730 whereupon a process payment window is displayed via the ClientApp 500, and input is processed as in block 732.

For the sake of example, we assume the merchant has selected the option to Process Payment from the functions available in block 725. The ClientApp 500 has accordingly proceeded to block 730 prompting the merchant with required and optional fields relevant to payment processing (such as amount, card number, invoice number, customer name, etc.) For the sake of description, let's refer to this as the “Construct Transaction” screen.

In the preferred embodiment, the input device 100 (e.g., card reader) is a secure device that encrypts critically sensitive payment card fields during the reading process and before sending that data via local interface 150. Industry standards incorporating encryption algorithms such as Advanced Encryption Standard (AES) or Triple Data Encryption Algorithm (3DES), with Derived Unique Key Per Transaction (DUKPT) encipher sensitive merchant data (such as Primary Account Number (PAN), Card Verification Value (CVV), etc.) to protect against unauthorized interception. The encrypted card data is sent through the ClientApp 500 to StrongBox's WebApp cluster 328 via a secure cryptographic internet protocol (such as a Secure Socket Layer (SSL) channel, Transport Layer Security (TLS) or other secure, encrypted connection). The WebApp cluster 328 opens a secure channel with the Card Decryption Service (which may be within the Secured Facilities or may be supplied via a 3^{rd} party) and sends an authenticated decryption request with the encrypted card data. The Card Decryption Service returns the unencrypted data to the WebApp cluster 328, which sends decrypted partial data to the ClientApp 500. Sensitive consumer data (such as credit card PAN or CVV) is masked or not returned from the database 322 to the ClientApp 500. This partial or masked response provides confirmation to the merchant of correct card reading, but reduces exposure of unencrypted card numbers to interception. The ClientApp 500 auto-fills relevant data fields returned by the WebApp cluster 328 in the Construct Transaction screen (such as name, PAN, expiration date, etc.) in block 732.

Card number fields may be made via keyed entry as represented in block 734. Keyed entry can be used to override card reader operation for any field. Optional fields such as invoice ID, and customer name may be manually keyed at any time within the Construct Transaction branch options (730-737). Card information may be optionally archived for future use by selecting that option while performing either Card Reader input 732 or Keyed Entry input 734. Selecting the archival option for card reader input 732 or keyed entry input 734 will invoke additional operations during and following transaction processing which are conventional.

When all requisite fields have been validated in block 740, the merchant may initiate processing the constructed payment transaction by clicking an appropriate button (for example, a “Process Payment” button) presented on the Construct Transaction screen in block 750. Upon initiating the transaction, the ClientApp 500 sends validated transaction fields via encrypted channel 300 to the WebApp cluster 328 for processing.

Upon receipt of the transaction request by ClientApp 500, the WebApp cluster 328 performs further data validation and logging. The WebApp cluster 328 then reformats the transaction request (if necessary) to meet syntax requirements of the merchant's selected payment processor. The WebApp cluster 328 then submits the appropriately formatted transaction data via telecommunications network 310 to said payment processor (Independent Service Organization(s) (ISO), Acquiring Bank, etc.) via a secured cryptographic connection. Transaction confirmation with identifying data is sent back to the WebApp cluster 328, which records the data and transmits relevant confirmation to the ClientApp 500 as depicted in block 760. The merchant can optionally print transaction receipts on the local receipt printer 400. Transaction history is always recorded by the WebApp cluster in the database 332 for subsequent merchant review or authorized download. Additionally, the WebApp cluster 328 can be optionally configured to send transaction confirmation messages and/or receipts to Users, Administrators, and/or Consumers via email, SMS, voice mail, etc.

When a User opts to store payment instrument data at either block 732 or 734, the decrypted data is sent from one part of the system (WebApp cluster 328) to another part of the system (the Encryption and Tokenization Appliance (ETA) 330) via a secure, cryptographic connection denoted by block 762. The ETA 330 encrypts the data using an encryption algorithm such as AES, or other suitable encryption algorithm. The encrypted data is tokenized (tokenization is the ability to replace sensitive data with equivalent non-sensitive data whose appearance and characteristics resemble that of sensitive data, but are valueless if divulged), and the token is stored securely in the Database 332. Conventional encryption key management protocols are strictly followed and may be automated.

When opting to perform a transaction using previously stored payment instrument data (block 736), the merchant is presented with a selection of previously stored payment instruments distinguished by a masked number value (for example, a 1+4 mask such as 4***********3456). Upon selecting a stored card number, the merchant may optionally configure a recurring payment schedule in block 737, specifying interval (e.g. daily, weekly, monthly) and iterations (1, 2, 3, X, infinite). After selecting any of these options, the remaining fields common to the Construct Transaction screen are validated in block 740 prior to the merchant initiating transaction by pressing the “Process Transaction” button in block 750.

As mentioned previously, following transaction processing, if a new payment instrument has been optionally specified for archive, WebApp 328 records associated tokenized card references in Database 332 for subsequent retrieval.

If the merchant has specified recurring transaction parameters, when constructing the payment transaction in block 737, WebApp 328 creates new corresponding schedule entries in Database 332 as depicted in block 766. Once created, scheduled payment transaction entries may be invoked automatically by the StrongBox system without merchant intervention at the specified date and time, using the amount, payment instrument, and other defined parameters. (This system driven operation is not depicted in FIG. 3.)

When a third party payor provides a payment (in the form of an Explanation of Benefits EOB or Electronic Remittance Advice (ERA)), the practice management systems (software) 342 update the database 332 to show the payment and determine the amount remaining due from the patient. The present invention includes software which prepares a new financial transaction according to a predetermined set of rules (every day, every week or whatever) and processes the new financial transaction through a preset system which may include presenting the proposed list of financial transactions to an operator for confirmation or override (Block 780). Once the process is followed, the new financial transactions involved (which may be a credit card charge) is then initiated and put onto the network for payment through the usual processing steps for such a transaction.

Finally, after processing at block 750 is completed, the operator can select a new function (returning to block 725) or exit the program.

e-Commerce Transactions

When employing the present invention for e-commerce transactions, the software 500 may be used as an embedded module within shopping cart software, as a hosted payment page on a website or using a standalone shopping cart. In this latter embodiment of a standalone shopping cart, it is more likely that sensitive payment instrument data will be manually keyed by the end user or cardholder themselves. The manually keyed data is sent from end user's computer 200 running an industry-standard web browser to the software in the webapp cluster 328 via a secured, cryptographic connection such as SSL, TLS, etc.

The payment transaction is similar as for payment processing transactions described in the foregoing paragraphs. Consumer payment instrument data can also be stored using this method.

POS as eCommerce: Enabling Cross-Border Transactions

The current invention offers flexibility to facilitate processing Point-of-Sale (POS) transactions as eCommerce transactions, enabling merchants to accept payment card compensation worldwide regardless of originating country or sale location. Because banks and ISOs frequently stipulate that merchants be resident in the same country when processing POS transactions, merchants often decline sales opportunities requiring POS payment outside their home country. Because the current invention facilitates secure card reader operations conveyed via worldwide telecommunication facilities (e.g. Internet, cellular/mobile, wireless, etc), remote POS transactions may be perceived as eCommerce transactions—similar to any web-based Shopping Cart accepting payment instruments internationally.

One example application of this capability could apply to merchants operating at temporary sales venues outside their home country. Current bank restrictions often forbid or frustrate POS transaction processing occurring outside a merchant's home location. By installing the current invention's ClientApp software 500 on a portable system having Internet connectivity at the desired sales venue, secure card reading operations can be performed just as are done in the merchant's home location. Examples of portable systems include notebook, laptop, tablet, or handheld terminals, easily relocated as required by merchant circumstances. While bank or ISO transaction processing percentage fees may be slightly higher for eCommerce transactions than for POS transactions, the current invention allows cross-border POS card processing in situations previously seen as untenable.

Of course, many modifications to the best mode described above may be effected without departing from the spirit of our invention. Further, some of the features disclosed may be useful without the corresponding use of other features. While the present invention has been described in connection with a credit card and its associated information, the present invention is not limited to a credit card and would work equally well with debit cards or checking account transactions. It could also be adapted to a draft system. Many alternatives are also possible without departing from the spirit of the present invention. For example, the use of an automated input device for reading a credit card could be modified to an OCR system for reading information from the card or a MICR reader for reading magnetic character information from a check. Near-field communications devices such as a NFC-enabled cell phone or other NFC-enabled mobile device (tablet computer, etc.) can be used to advantage in this invention, if desired.) Accordingly, the foregoing description of the preferred embodiment should be considered as merely illustrative of the principles of the present invention and not in limitation thereof. The scope of the present invention is to be determined solely by the claims which follow.

Having thus described the invention, what is claimed is:

1. A method for processing a financial transaction comprising the steps of:
reading financial information from a document relating to a customer and storing it in a secure memory;
later, determining that additional payment is due from the customer and determining the financial information for that customer from the information in the stored memory; and
using the determined financial information from the stored memory to initiate a financial transaction after the amount of the additional payment has been determined.

2. A method of the type described in claim 1 wherein the method further includes the step of reading information from a credit card and the step of using the information includes the step of using the information from the credit card to initiate a credit card transaction.

3. A method of the type described in claim 1 further including the step of providing a record of the initiated financial transaction and using the record to update the account.

4. A method of the type described in claim 1 wherein the step of determining that additional payment is due includes the step of receiving information from a third-party payor and using that information to update the account.

5. A method of the type described in claim 1 wherein the step of determining that additional payment is due includes the step of receiving an explanation of benefits from an insurance company and applying the payments and other credits from the explanation of benefits to the customer's account.

6. A method of the type described in claim 5 wherein the explanation of benefits is received electronically and the account is updated using software which recognizes the information from the electronic explanation of benefits.

7. A method of the type described in claim 1 wherein the method further includes the step of processing a first financial transaction at the time the financial information is read and the later processing of a second transaction is in response to data received from a third party.

8. A method of the type described in claim 1 wherein the method includes the step of encrypting information to reduce the chance of compromise.

9. A method of the type described in claim 1 further including the step of providing a customer receipt showing the transaction which has been initiated.

10. A system for processing a financial transaction comprising:
an input device for obtaining financial information relating to a customer and storing it in memory;
a system for receiving charge information relating to the customer and payment information about third party payments relating to the customer and updating the customer's account in response to the third party payments;
a system for determining that the customer owes additional charges after the payment information has been stored; and
preparing a financial transaction to collect the additional charges by using the stored financial information.

11. A system of the type described in claim 10 further including a module for initiating a first financial transaction from the stored financial information at about the time the charges are incurred and a second financial transaction from the stored financial information after information from a third party payor has been received.

12. A system of the type described in claim 10 wherein the system includes end-to-end security to reduce the chance that the financial information will be improperly disclosed.

13. A system of the type described in claim 12 wherein the security complies with industry standards.

14. A system of the type described in claim 13 wherein the security complies with the PCI-DSS standards.

15. A program stored on a medium which includes the following:
a first module for collecting financial information relating to a customer and securely storing that financial information;
a second module for determining the customer's balance after posting his charges and payments;
a third module for using the stored financial information for initiating a first financial transaction at one time and a second transaction at a later time for the customer's balance based on using the customer's balance from the second module and the financial information from the first module.

16. A program of the type including the modules of claim 15 wherein the second module includes a system for receiving information about a third party payment on the customer's account and determining a deficiency in the payment and the third module includes preparing a financial transaction for the deficiency.

17. A program of the type which includes the modules of claim 16 wherein the third module includes a system for presenting a charge to a credit card.

18. A program of the step including the modules of claim 15 and further including end-to-end security of the type which complies with industry standards.

19. A program of the type including the modules of claim 18 wherein the industry standard comprises PCI-DSS standards.
